(19) United States
(12) Patent Application Publication
(10) Pub. No.: US 2020/0057982 A1
(43) Pub. Date: Feb. 20, 2020

(54) SYSTEM AND METHOD FOR FUEL STORAGE TANK INVENTORY MANAGEMENT

(71) Applicant: EDGE PETROL LIMITED, London (GB)

(72) Inventors: Gideon CARROLL, London (GB); Neil DANIELS, London, Greater London (GB)

(21) Appl. No.: 16/346,838

(22) PCT Filed: Oct. 26, 2017
(86) PCT No.: PCT/GB2017/053236

§ 371 Date: May 1, 2019

(30) Foreign Application Priority Data
Nov. 2, 2016 (GB) 1618492.1

(51) Int. Cl. G06Q 10/08; G06Q 30/02; G06Q 10/06; G06Q 10/04

(52) U.S. Cl. CPC G06Q 10/087; G06Q 30/0206; G06Q 10/06315; G06Q 10/04; G06Q 10/06312

(57) ABSTRACT

A computer implemented system for fuel tank inventory management at a filling station comprises a fuel demand predictor to predict future fuel demand for the fuel at the filling station, a local fuel price obtaining means arranged to obtain a local fuel price for the fuel at the filling station, and a fuel price obtaining means arranged to obtain a fuel price for the fuel for at least one other filling station. The fuel demand predictor is arranged to predict future fuel demand for the fuel at the filling station based at least in part upon a comparison of the local fuel price at the filling station and the fuel price for the at least one other filling station. The system further comprises a fuel stock means arranged to obtain a current amount of the fuel stored at the filling station, a fuel stock predictor arranged to predict a future amount of the fuel stored at the filling station based upon the current amount of the fuel at the filling station and the predicted future fuel demand for the fuel at the filling station, and output means arranged to output the predicted future amount of the fuel stored at the filling station.

The present application relates to a system and method for fuel storage tank inventory management, and in particular for fuel storage tank inventory management in vehicle filling stations.

### BACKGROUND

Vehicle filling stations maintain stored stocks of fuel, generally in underground storage tanks, for sale to customers, such as retail customers. In operation of a filling station these fuel stocks are depleted by sales to customers, so that the filling station must be restocked with fuel from time to time by a fuel delivery. Generally these fuel deliveries are carried out by road tanker vehicles.

The fuel is typically supplied, stored and sold in a number of different grades and forms, for example petrol (also called gas or gasoline in some countries, such as the USA and Canada) and diesel fuel, and both petrol and diesel fuel may be sold in a number of different grades having different formulations. These different types and grades of fuel are stored in separate storage tanks, command different prices, and are typically sold at different rates.

It is important that the stock of stored fuel of each type and grade at a filling station is managed by arranging the timing and volume of the fuel deliveries so that there is always a stock of fuel of each type and grade available in the storage tanks of the filling station for sale and supply to customers. However, since the customers are independent of the filling station it may be difficult to accurately predict future sales and stocks of the various fuel types and grades, making management of the fuel tank inventory difficult.

It is also desirable not to maintain fuel stock levels at a filling station unnecessarily high by frequent restocking. Such frequent restocking can increase the complexity of the logistics task of carrying out the restocking and increase the number of tanker vehicles required to carry out the deliveries, in addition to increasing the environmental and financial costs of operating the tanker vehicles.

Further, once fuel has been delivered and placed in a storage tank at a filling station it is generally not acceptable, for safety reasons, logistical reasons, and to prevent contamination, to remove the fuel and deliver it to another filling station. As a result, from the perspective of the overall fuel supply chain, holding a large proportion of the available fuel at filling stations may reduce the amount of fuel available for delivery, making it harder to service sudden surges in demand for fuel at specific filling stations, and so reducing the flexibility and resilience of the overall fuel supply chain.

Accordingly, it is desirable to be able to predict future demand for fuel at a filling station so that fuel storage tank inventories can be accurately managed.

The embodiments described below are not limited to implementations which solve any or all of the disadvantages of the known approaches described above.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The present disclosure provides a system for predicting an amount of a fuel stored at a filling station by predicting future fuel demand based on fuel prices at the filling station and another filling station, using the predicted fuel demand and the current amount of stored fuel to predict a future amount of stored fuel.

In a first aspect, the present disclosure provides a computer implemented system for fuel storage tank inventory management at a filling station, the system comprising; a fuel demand predictor arranged to predict future fuel demand for the fuel at the filling station; a local fuel price obtaining means arranged to obtain a local fuel price for the fuel at the filling station; and a fuel price obtaining means arranged to obtain a fuel price for the fuel for at least one other filling station; wherein the fuel demand predictor is arranged to predict future fuel demand for the fuel at the filling station based at least in part upon a comparison of the local fuel price at the filling station and the fuel price for the at least one other filling station; and further comprising: a fuel stock means arranged to obtain a current amount of the fuel stored at the filling station; a fuel stock predictor arranged to predict a future amount of the fuel stored at the filling station based upon the current amount of the fuel at the filling station and the predicted future fuel demand for the fuel at the filling station; and output means arranged to output the predicted future amount of the fuel stored at the filling station.

In a second aspect, the present disclosure provides a computer implemented method for fuel storage tank inventory management at a filling station, the method comprising: predicting future fuel demand for the fuel at the filling station; obtaining a local fuel price for the fuel at the filling station; and obtaining a fuel price for the fuel for at least one other filling station; wherein future fuel demand for the fuel at the filling station is predicted based at least in part upon the local fuel price at the filling station and the fuel price for the at least one other filling station; and further comprising: obtaining a current amount of the fuel stored at the filling station; predicting a future amount of the fuel stored at the filling station based upon the current amount of the fuel at the filling station and the predicted future fuel demand for the fuel at the filling station; and outputting the predicted future amount of the fuel stored at the filling station.

In a third aspect, the present disclosure provides a computer program comprising a plurality of computer readable instructions arranged such that, when executed on a processor of a computer they cause the computer to carry out the method according to the third aspect.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, solid-state memory, memory cards etc and do not include propagated signals. The software can be suitable for execution on a parallel processor or a serial processor such that the method steps may be carried out in any suitable order, or simultaneously.

This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is a schematic diagram of a filling station where an embodiment of the invention may be used;

FIG. 2 is a schematic diagram of a system for fuel storage tank inventory management at a filling station according to an embodiment of the present invention;

FIG. 3 is a flow diagram of a method for predicting fuel stocks carried out by the system of FIG. 1 according to the embodiment of the invention;

FIG. 4 is a schematic diagram of a system for providing fuel price information to the system of FIG. 1 according to the embodiment of the present invention;

FIG. 5 is a schematic diagram of a system for fuel storage tank inventory management at a filling station according to another embodiment of the present invention; and

FIG. 6 is a schematic diagram of a system for providing fuel cost information to the system of FIG. 1 according to the embodiment of the present invention.

Common reference numerals are used throughout the figures to indicate similar features.

### DETAILED DESCRIPTION

An embodiment of the present invention is described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

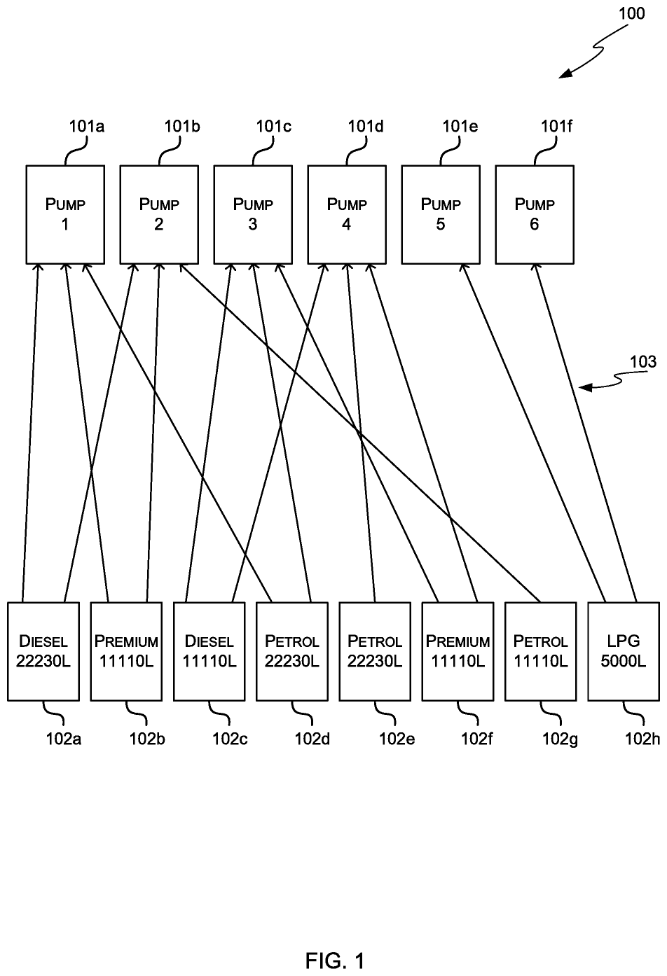

FIG. 1 illustrates an example of a filling station where a fuel storage tank inventory management system according to an embodiment of the present invention may be used. A filling station, also commonly known as a service station, petrol filling station, forecourt, garage or gas station, is a fuel supply site selling fuel for road vehicles to customers. The customers may include retail customers, and may typically also include other types of customer, for example customers provided with fuel under a contract, or customers using fuel cards.

The filling station may sell one or more different fuel types and grades, and each fuel type and grade may be stored in one or more different storage tanks.

FIG. 1 illustrates by way of example a filling station 100 having six pumps 101a to 101f, each for the supply of fuel to customers. The filling station 100 sells standard grade petrol, premium grade petrol, diesel and liquid petroleum gas (LPG), that is, three fuel types, with one fuel type sold in two different grades, for a total of four unique fuel/grade combinations. The six pumps 101a to 101c1 are arranged so that each of the pumps 101a to 101d can supply each of standard grade petrol, premium grade petrol and diesel to customers, while the pumps 101e and 101f can only supply LPG to customers.

The filling station has eight underground fuel storage tanks 102a to 102h. Tank 102a contains diesel and has a maximum capacity of 22,230 liters. Tank 102b contains premium petrol and has a maximum capacity of 11,110 liters. Tank 102c contains diesel and has a maximum capacity of 11,110 liters. Tank 102d contains petrol and has a maximum capacity of 22,230 liters. Tank 102e contains petrol and has a maximum capacity of 22,230 liters. Tank 102f contains premium petrol and has a maximum capacity of 11,110 liters. Tank 102g contains petrol and has a maximum capacity of 11,110 liters. Tank 102h contains LPG and has a maximum capacity of 5,000 liters.

In order to allow the pumps 101a to 101f to provide the desired fuels the pipework 103 at the filling station connects pump 101a to tanks 102a, 102b, and 102d, connects pump 101b to tanks 102a, 102b and 102g, connects pump 101c to tanks 102c, 102d, and 102f, connects pump 101d to tanks 102c, 102e, and 102f, connects pump 101e to tank 102h, and connects pump 101f to tank 102h.

Thus, diesel tank 102a supplies fuel to two pumps 101a and 101b and has a maximum capacity of 22,230 liters, while diesel tank 102c also supplies two pumps 101c and 101d, but only has a capacity of 11,100 liters. Premium petrol tank 102b supplies fuel to two pumps 101a and 101b and has a maximum capacity of 11,110 liters, and premium petrol tank 102f supplies fuel to two pumps 101c and 101d and also has a maximum capacity of 11,110 liters. Petrol tank 102d supplies fuel to two pumps 101a and 101c and has a maximum capacity of 22,230 liters, petrol tank 102e supplies fuel to only one pump 101d and also has a maximum capacity of 22,230 liters, and petrol tank 102g supplies fuel to only one pump 101b and has a maximum capacity of 11,110 liters. Finally, LPG tank 102h supplies fuel to two pumps 101e and 101f and has a maximum capacity of 5,000 liters.

It will be understood that because the storage of most of the different fuel and grade combinations on sale is split between multiple separate storage tanks, which may contain different amounts of fuel and supply different numbers of pumps, the task of fuel storage tank inventory management for all of the different fuel storage tanks 102a to 102h at the filling station 100 may be complex to carry out efficiently. This is particularly the case because it is usually not possible, for safety reasons, logistics reasons, and to prevent fuel contamination, to transfer fuel between different storage tanks in a filling station, even when the storage tanks contain the same type and grade of fuel.

It might be expected that a simpler arrangement may be preferred in a new build filling station, for example, it may be preferred for each fuel and grade combination to be stored in a single storage tank. However, such a simple arrangement may be difficult to adapt if the number of fuels and grades to be sold changes over time, so a more complex arrangement with more storage tanks may be preferred to provide increased long term flexibility. Further, many existing filing stations have relatively complex arrangements of fuel storage tanks for legacy reasons, because it is generally more physically and economically practical to increase storage capacity by adding new storage tanks than by enlarging existing storage tanks, or replacing existing storage tanks with larger storage tanks.

The example of FIG. 1 is provided only as an explanatory example to illustrate that a filling station may have more than one tank storing some types or grades of fuel. The number of pumps, types and grades of fuel sold, the number of storage tanks, and the interconnections between the pumps and tanks may all be varied in specific implementations of the invention.

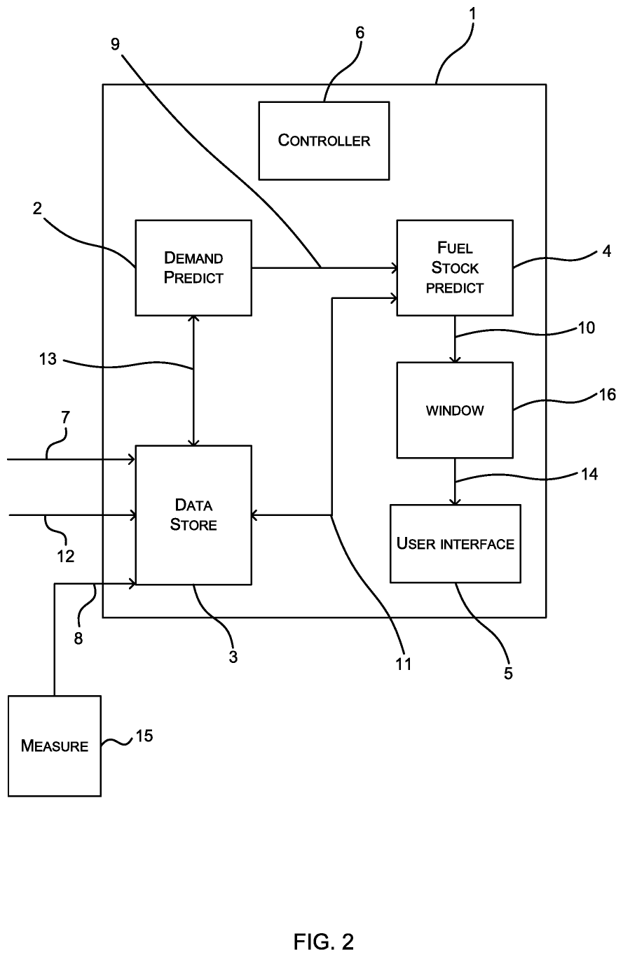

FIG. 2 illustrates a system for carrying out fuel storage tank inventory management at a specific filling station by predicting future demand for a fuel at that specific filling station, determining how this predicted level of demand will affect the fuel stock level and determining a window for replenishment of the fuel stock. In the present application the amount of fuel sold to customers, and so removed from storage at the filing station and taken away by the customers, is regarded as the amount of demand for fuel, so that a predicted level of demand for fuel is a prediction of the amount of fuel which will be sold.

As is explained above, filling stations commonly stock a plurality of different fuel types and/or grades, which are stored separately, and each but to improve clarity the invention will be initially described in relation to a single fuel type and grade only.

In FIG. 2, according to an embodiment of the invention a fuel storage tank inventory management system 1 at a filling station comprises a fuel demand prediction engine 2, a data store 3, a fuel stock predictor 4, a user interface 5, and a system controller 6.

An overview of the operation of the fuel storage tank inventory management system 1 is that the fuel storage tank inventory management system 1 is provided with a number of information inputs 7 regarding current and anticipated future factors which may influence current and future fuel demand, stored fuel information 8 regarding the current amount of fuel stored at the filling station, and site specific characteristics information 12, and these are stored in the data store 3 under the control of the system controller 6. The prediction engine 2 operates on stored data 13 selected from the stored information inputs 7 and site specific characteristics information 12 using predictive tools taken from the data store 3 to generate predicted values of future fuel demand 9. The predicted values of future fuel demand 9 and the stored fuel information 8 are then provided to the fuel stock predictor 4. The fuel stock predictor 4 uses the predicted values of future fuel demand 9 and stored fuel information 8 to determine predicted amounts 10 of stored fuel at the filling station at different times in the future. The predicted amounts 10 of stored fuel at the filling station at different times in the future are then provided to a window determining unit 11, which determines a safe window 14 for a fuel supply delivery to be made. In this context a “safe” window means a window of time in which deliveries are possible having regard to the scheduling of the fuel delivery organization, and which avoids one or more storage tanks inadvertently running dry. Use of this safe window 14 to schedule fuel deliveries may avoid replenishing the fuel storage tanks at an unnecessarily early time. The safe window 14 is then provided to the user interface 5 for display to an operator of the system 1 for information and action. In some examples the operator of the system 1 may be a member of staff, such as a manager, at the filling station. In other examples the system 1 may be remotely operated by a remote operator, such as a head office of a chain of filling stations.

The prediction engine 2 may be an expert system in which the different values of the different parameters which can affect fuel demand at the service station are processed using predictive tools stored in the data store 3, and the cumulative effects of all of the different parameters are combined to provide an expected fuel demand value for a future time period.

In the illustrated example the stored fuel information 8 is obtained from a measuring means 15 which measures the amount of fuel in a storage tank at the filling station and provides this to the fuel tank inventory management system 1. In other examples the stored fuel information 8 may alternatively, or additionally as a cross-check, be obtained from other parts of the filling station equipment, for example from the filling station site controller or a filling station point of sale system. In some examples the stored fuel information 8 may be provided by a measuring means which measures the amount of fuel in a storage tank at the filling station and provides this to the filling station point of sale system, or the filling station site controller.

The fuel storage tank inventory management system is shown schematically in FIG. 1. It will be understood that the fuel storage tank inventory management system 1 may in practice comprise a number of other components, but these are not described or shown to improve clarity and to avoid obscuring the scope of the present invention.

In the illustrated example the fuel storage tank inventory management system 1 is provided by a suitable general purpose computer at the filling station running fuel stock prediction software. The different functional parts of the fuel stock prediction system 1 may be provided by software modules operating on the general purpose computer. This general purpose computer may, for example, be a desktop computer, a laptop computer, a tablet, or a smartphone.

In the illustrated example the fuel storage tank inventory management system 1 makes predictions of future fuel demand with a granularity of one day. That is, the fuel tank inventory management system 1 predicts the amount of demand for fuel at the filling station for each day, the resulting predicted amount of fuel remaining in storage at the filling station at the end of each day is determined, and the safe window for a fuel delivery is determined as a number of days or hours within which a fuel delivery must be made. In other examples different time periods and granularities of the predictions of future fuel demand and remaining fuel stores may be used if desired.

FIG. 2 illustrates a flow chart of a method 20 of predicting fuel stocks. The method 20 starts, in block 21, to generate a prediction of future fuel stock values at the filling station. In general the system 1 will be operating continuously so that the predictions are continuously updated as new data becomes available, to provide a real time, or near real time prediction.

In other examples the fuel storage tank inventory management system 1 may only make a prediction in response to an instruction, such an instruction may for example be input by an operator of the fuel stock prediction system 1.

The system controller 6 instructs the prediction engine 2 to generate a prediction of future fuel demand for a first specific day of interest in the particular period of time in block 22. In the example the first specific day considered will generally be the current day, or the following day if the filling station has closed for the night, but this is not essential.

The prediction engine 2 recovers from the data store 3 an appropriate baseline value for fuel demand on the specific day in block 23. The data store 3 includes baseline values of fuel demand for each day of the week derived from analysis of historical data. For example, the baseline fuel demand value for a Wednesday may be the average fuel demand averaged over all Wednesdays in available historical data. The data store may include different baseline fuel demand values to be used if the specified day is one when that day of the week is a public holiday. These baseline fuel demand values may conveniently be stored in the data store 3 in the form of tables.

The prediction engine 2 then alters the baseline fuel demand value for the day based on the received information inputs 7 regarding the factors which may affect fuel demand at the filling station which are stored in the data store 3 for that day. The prediction engine 2 processes the stored information input 7 associated with each factor for the day under consideration in order. The relevant information inputs 7 may, for example, include notifications of relevant events taking place on that day and/or values of relevant parameters for that day. In practice, the information inputs 7 will generally have be received asynchronously at different times and stored in the data store 3 together with an indication which day or days each of the stored information inputs 7 applies to under the control of the controller 6.

The prediction engine 2 obtains and processes a stored information input 7 relating to a first factor and an associated algorithm from the data store 3, in block 24. The algorithm indicates how the factor affects fuel demand, and specifically how the value of the associated stored information input 7 for the factor affects fuel demand. The prediction engine 2 then processes the obtained information input 7 by executing the associated algorithm using the associated stored information input value 7 to determine how much the baseline demand value should be adjusted upwards or downwards based upon the factor, and adjusts the demand value accordingly to provide an adjusted demand value.

The prediction engine 2 then determines in block 25 whether the stored information inputs 7 have been processed for all factors. If not, the prediction engine returns to block 24 and repeats the obtaining and processing for the stored information input 7 relating to the next factor.

When the prediction engine 2 determines in block 25 that the stored information inputs 7 have been processed for all factors, the prediction engine outputs a final adjusted demand value based on all of the factors to the fuel stock predictor 4 in block 26. This final adjusted demand value is the predicted value of future fuel demand 9 for the day of interest.

The prediction engine 2 then waits at block 27 to be informed whether a prediction of future fuel demand for a next specific day of interest is required.

The final adjusted demand value output by the prediction engine 2 in block 26 providing the predicted value of future fuel demand 9 for the day of interest is supplied to the fuel stock predictor 4.

The fuel stock predictor 4 obtains the predicted value of future fuel demand 9 for the day of interest from the prediction engine 2 and obtains a stored fuel stock value 11 of the amount of fuel stored at the filling station at the start of the day of interest from the data store 3, in block 29.

The fuel stock predictor 4 subtracts the predicted value of future fuel demand 9 for the day of interest from the fuel stock value at the start of the day of interest to determine a predicted amount of fuel stored at the filling station at the end of the day of interest in block 30.

In some examples, where the day of interest is the current day the fuel stock predictor 4 may in block 29, instead obtain the predicted value of future fuel demand 9 for the current day of interest from the prediction engine 2, and use this to determine a predicted value of fuel demand for the remainder of the day. In one example the predicted value of fuel demand for the remainder of the day may be based on the proportion of the day remaining. The fuel stock predictor 4 may also obtain a stored fuel stock value 11 of the amount of fuel currently stored at the filling station from the data store 3. The fuel stock predictor 4 may then use these to determine a predicted amount of fuel stored at the filling station at the end of the current day of interest, or at any other future time of day of interest, in block 30.

The predicted amount of fuel stored at the filling station at the end of the day of interest is stored in the data store 3, and is output to the window determining unit 16.

It will be understood that if the day of interest is the current day, or the following day if the filling station has closed for the night, the fuel stock value at the start of the day of interest will be the stored fuel information 8. If the day of interest is a subsequent day the fuel stock value at the start of the day of interest will be a stored predicted value.

The window determining unit 16 obtains the predicted amount of fuel stored at the filling station at the end of the day of interest from the fuel stock predictor 4 and compares this to a threshold fuel reserve amount in block 31. The threshold reserve amount is a predetermined positive value in order to prevent the amount of fuel in the tank being fully depleted, and to prevent the amount of fuel in the tank being depleted below a minimum safe value. Generally, impurities, such as dirt, tend to accumulate in the bottoms of fuel storage tanks over time so that it is generally preferred not to deplete the amount of fuel in the tank below a predetermined level in order to avoid providing contaminated or dirty fuel to customers.

In some examples the fuel storage tank may have a low fuel level sensor and alarm in order to provide a warning that the amount of stored fuel has reached, or dropped below, a predetermined minimum value so that the supply of fuel from the tank can be stopped to avoid providing contaminated or dirty fuel to customers. In such examples the threshold reserve amount may conveniently be set to be the same as, or slightly above, this minimum value so that the low fuel level sensor and alarm are not activated.

In some examples the threshold may be derived from the predicted value of future fuel demand for that day, for example as a fraction or percentage of predicted daily demand.

In some examples the threshold fuel reserve amount may be zero.

If the predicted amount of fuel is determined in block 31 to be above the threshold the window determining unit 16 informs the prediction engine 2 that a prediction of future fuel demand for a next specific day of interest is required.

The prediction engine 2 responds to this by leaving block 27, and returns to block 22 and generates a prediction of future fuel demand for a next specific day of interest, so that the prediction engine 2 repeats the method of blocks 22 to 27 for the next day, including outputting a final adjusted demand value for the next specific day of interest to the fuel stock predictor 4 in block 26. The fuel stock predictor 4 repeats steps 29 and 30 for the final adjusted demand value for the next day of interest to determine a predicted amount of fuel stored at the filling station at the end of the next day of interest. The window determining unit 16 obtains the predicted amount of fuel stored at the filling station at the end of the next day of interest from the fuel stock predictor 4 and compares this to the threshold fuel reserve amount in block 31.

Accordingly, steps 22 to 31 are repeated so long as the predicted amount of fuel stored at the filling station at the end of each successive next day is above the threshold. Although periods of a day are shown by way of example, other regular or irregular time periods for the prediction of the amount of fuel stored at the end of a time period may be used.

If the predicted amount of fuel is determined in block 31 to be at or below the threshold the window determining unit 16 informs the prediction engine 2 that no prediction of future fuel demand for a next specific day of interest is required. The prediction engine 2 responds to this by leaving block 27, and ending the prediction sequence in block 28.

If the predicted amount of fuel is below the threshold in block 31 the window determining unit 16 determines that the specific day of interest for which this prediction has been made is the final day of a safe fuel delivery window, and that a fuel delivery must be received before the end of that specific day of interest. In some examples the window determining unit 16 may determine that a fuel delivery must be received before the end of the day preceding the day predicted to have a value below the threshold.

The fuel tank inventory management system 1 provides the final day of the safe delivery window and the predicted amount of fuel stored at the filling station at the end of each day within the safe delivery window to the operator through the user interface 5, in block 32.

The operator can then use the user interface 5 to request and schedule a fuel delivery of a desired amount within the safe delivery window.

As is explained above, the operator is informed of the safe delivery window, indicating the final day on which a fuel delivery must be received. The predicted amounts of stored fuel and identified end of the safe delivery window may be used by the operator as a basis for scheduling fuel deliveries to ensure that the filling station does not run out of stored fuel for supply to customers. This may allow the holding of unnecessarily high stocks of fuel and unnecessarily frequent restocking to be avoided. In some examples the deliveries may be arranged at times which reduce the environmental and financial costs of operating the delivery vehicles, or optimize the route taken by a fuel delivery vehicle.

The fuel storage tank inventory management system 1 may also inform the operator through the user interface 5 of any stored site specific characteristics information 12 which may be relevant to the scheduling of a fuel delivery. Some examples of such site specific characteristics information 12 include limits on the maximum size of tanker vehicle which can access the tank filling point, and limitations on the times and/or dates when fuel deliveries can be received. Such limitations may be practical in nature, such as times when sufficient trained staff are on duty to receive the delivery, or the amount of prior notice required for a delivery to be made, or alternatively may be legal/contractual in nature, such as agreements or covenants limiting the filling station to particular delivery times. This is not intended to be an exhaustive list and other site specific characteristics are possible.

Where the limitations on fuel deliveries are practical in nature the operator may take action to change these, such as changing staffing rosters. When the stored site specific characteristics information 12 has been updated to reflect the change, the fuel tank inventory management system 1 may inform the operator through the user interface 5 of the changed stored site specific characteristics information 12. For example, where staffing rosters are changed in a staff scheduling system for the filling station, the staff scheduling system may automatically provide the updated staffing roster to the system 1. In other examples the systems may be integrated so that a change to the staffing roster can be requested using the user interface 5.

In other examples the maximum amounts of fuel which could be accepted for delivery on each day or other period of the safe window may be provided to the operator instead of, or in addition to, the predicted amounts of stored fuel. In some examples the maximum amounts of fuel which could be accepted for delivery on each day or other period of the safe window may correspond to the predicted empty volume, or ullage, in the tank or tanks of the filling station. This predicted empty volume may be determined by subtracting the predicted amount of fuel stored at the filling station from the maximum amount of fuel which can be stored.

In some examples the final day of the safe delivery window, or the period of time by which a delivery must be received, may not be determined or identified to the operator. In such examples the predicted amounts of stored fuel will allow the available safe window for receiving fuel deliveries to be identified by the operator, so that deliveries can be arranged at an advantageous time within this window.

In some examples the predicted amount of fuel stored at the filling station at the end of each day within the safe delivery window may not be provided to the operator, but only the final day of the safe delivery window.

In some examples the fuel storage tank inventory management system 1 may automatically request a fuel delivery from a fuel supplier before the end of the safe delivery window.

In some examples the fuel tank inventory management system 1 may not be used to request and schedule fuel deliveries and the operator must request and schedule a fuel delivery based on the information provided by the fuel storage tank inventory management system 1 using other means.

The example described above relates to a fuel tank inventory management system for a single fuel type and grade stored in a single tank. In other examples the fuel tank inventory management system may be configured to predict demand for different types and grades of fuel stored in different tanks, and to determine safe delivery windows for the different tanks. Further, the fuel tank inventory management system may be configured to aggregate data across the fuel types, grades and tanks, so as to predict the optimal window for refilling all of the storage tanks at the filling station, or for refilling some or one of the storage tanks containing one or some of the fuel types or grades stored at the filling station. Such aggregation may include aggregation by volume, available stocks, price, or a weighted combination thereof.

If the location of the filling station is such that demand for fuel is affected by a scheduled public event the prediction engine 2 may take into account whether such an event is scheduled to occur or not on the day of interest. For example, if the filling station is near a racetrack or sport stadium the predicted demand for fuel may be significantly different on race or match days than on other days. In some examples this may be done by using a different baseline value for event days and non-event days. In other examples this may be done by selectively adjusting the demand value based on whether a corresponding stored information input indicates and event day or a non-event day.

In the illustrated embodiment, one element affecting the fuel demand at a filling station which is taken into account by the prediction engine 2 is the price at which the fuel is offered for sale at that filling station. Unlike most other factors which may affect the fuel demand at the filling station this sale price is under the control of the operator of the filling station. This price is commonly referred to as the pole sign price, because this is generally prominently displayed at the filling station, usually on a sign mounted on a pole.

In the illustrated embodiment, one factor taken into account by the prediction engine 2 is the price or prices at which fuel is offered for sale at the filling station and at other nearby filling stations located locally to the filling station. A nearby filling station may be regarded as located locally to the filling station if the two filling stations compete for the same business or customers. The fuel demand at a filling station may be affected by the relative prices of fuel at that filling station and at the other nearby filling stations located locally to that filling station. In one example nearby filling stations may be defined as being located locally if they are within 5 km of the filling station. In other examples different distances or criteria may be used, which may be influenced by local geography, such as the denseness of the local road network.

In the illustrated embodiment the prediction engine 2 is provided with the fuel price at the filling station automatically by the filling station point of sale system. In other examples this fuel price may be provided by other parts of the filling station equipment. In some examples the operator can input this fuel price into the fuel stock prediction system, for example by using the user interface 5.

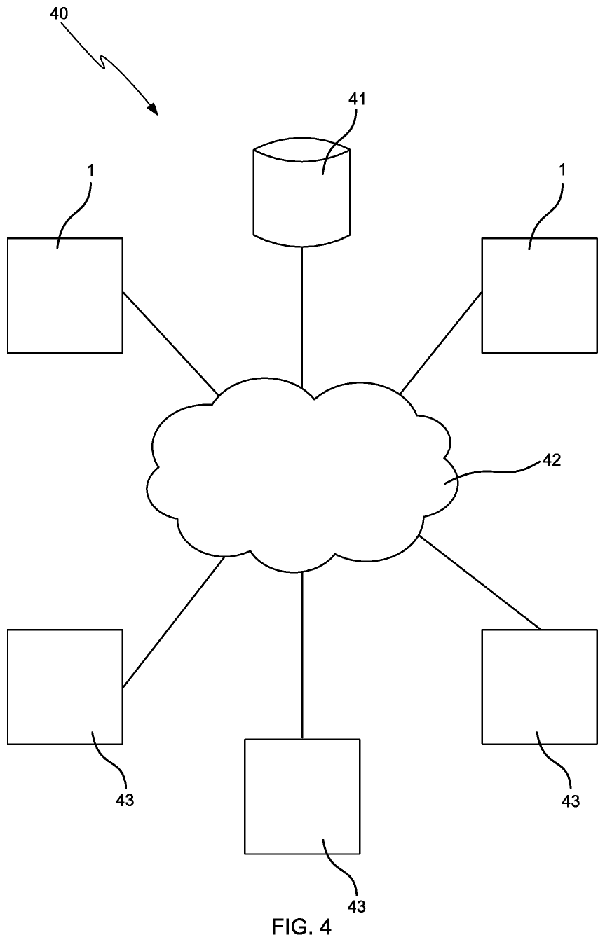

FIG. 4 illustrates a fuel price data system for providing the fuel storage tank inventory management system 1 with real time data regarding fuel prices at other nearby filling stations.

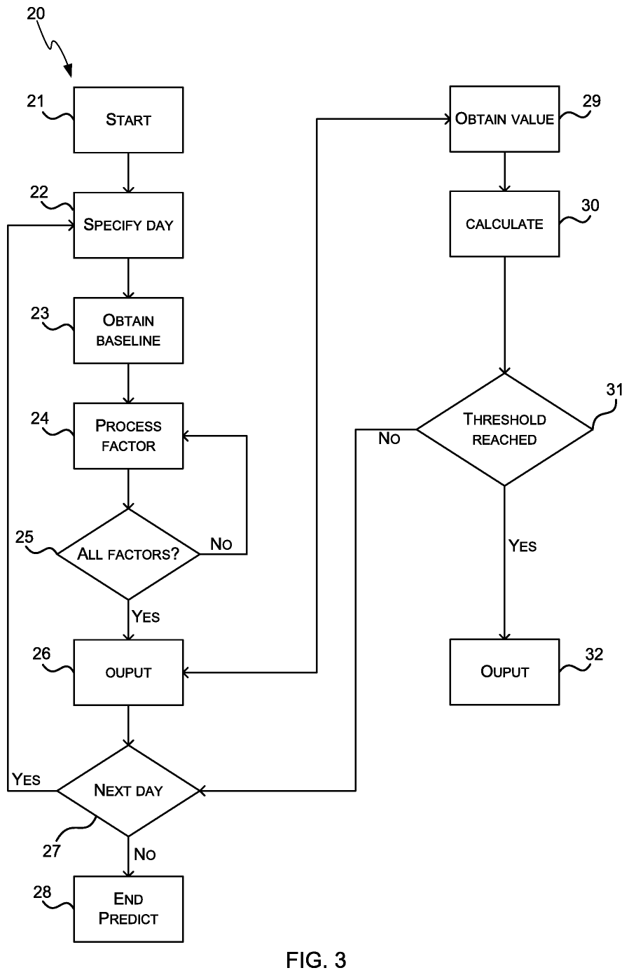

In FIG. 4, the fuel price data system 40 comprises a central fuel price collector 41. The fuel price collector 41 is connected to a number of different fuel storage tank inventory management systems 1 located at respective different filling stations through a communications network 42. The central fuel price collector 41 is also connected to a number of fuel price reporting systems 43 at other respective filling stations through the communications network 42. FIG. 3 shows only three fuel price reporting systems 43 and two fuel storage tank inventory management systems 1. It will be understood that in practice there may be any number of fuel price reporting systems 43 and fuel storage tank inventory management systems 1 in the fuel price data system 40, and possibly a very large number.

The communications network 42 may be a public communications network, such as the Internet. The central fuel price collector 41 may be arranged to operate as a server.

In operation, the central fuel price collector 41 receives notifications from each of the fuel storage tank inventory management systems 1 and fuel price reporting systems 43 making up the fuel price data system 40 regarding the current fuel price at their respective filling station. The central fuel price collector 41 stores this current fuel price information together with the identity of the respective filling station from which the fuel price information was received in a database. In one example these notifications are sent periodically, and also when the fuel price changes. In other examples these notifications may be sent only periodically, or only when the fuel price changes.

The central fuel price collector 41 is central in the sense that it is a central part of the functionality and organization of the system. The term central does not imply anything regarding the physical or geographical location of the different parts of the system.

In the illustrated example, each fuel price reporting system 43 is integrated with the electronic systems at a filling station, and automatically obtains fuel price information from the filling station systems and sends notifications of the price information to the central fuel price collector 41. The fuel price reporting system 43 may obtain the fuel price information from a number of different parts of the filling station systems. In practice it may be necessary for different fuel price reporting systems 43 to obtain information in different ways depending on the specific systems installed at a particular filling station, since these systems are not generally standardized. The fuel price reporting system 43 may, for example, obtain the fuel price information from a site controller, from a smart controller or smart interface of a pay-at-pump system, or from an electronic point of sale (epos) system. This is not intended to be an exhaustive list, and other arrangements may be possible. The fuel price reporting system 43 may be a dedicated hardware device connected to a filling station system, or may be software installed on a filling station system.

In an alternative example, each fuel price reporting system 43 is a reporting program, such as an a App, running on a computer at the filling station and used by filling station personnel to manually input the fuel price information. The fuel price reporting system 43 automatically sends notifications of the input price information to the central fuel price collector 41. This computer may, for example, be a desktop computer located at the filling station, or a mobile device such as a laptop computer, a tablet, or a smartphone used by filling station personnel.

In some examples a mixture of these different types of fuel price reporting systems 43 may be used.

The central fuel price collector 41 maintains a record for each of the fuel storage tank inventory management systems 1 indicating the identities of the other filling stations which are regarded as local to that fuel storage tank inventory management system 1 in a database. The central fuel price collector 41 sends each fuel storage tank inventory management system 1 price data identifying the current fuel price of at each of the filling stations identified as local to the filling station where that fuel tank inventory management system 1 is located, so that the fuel storage tank inventory management system 1 is informed in real time regarding changes to the fuel prices at these local filling stations. In one example this price data is sent periodically, and also when the fuel price data changes. In other examples the fuel price data may be sent only periodically, or only when the fuel price data changes.

As is discussed above, the identification of filling stations as local to the filling station of a fuel storage tank inventory management system 1 is based on location and the local road network. However, filling stations do not move and significant changes to the road network are relatively rare. Accordingly, it is usually only necessary to determine and compare the locations of filling stations in order to determine which filling stations are to be identified as local to one another when a new filling station is added to the fuel price data system 40. It is not generally necessary for the central fuel price collector 41 to compare the locations of the different filling stations on an ongoing basis, except when newly opened filling stations are added to, or newly closed filling stations are deleted from, its database. The central fuel price collector 41 may also respond to a significant change in the road network by comparing the locations of the different filling stations, or of selected filling stations in the area where the change has occurred.

The price data sent by the central fuel price collector 41 to each fuel storage tank inventory management system 1 provides one of the information inputs 7 to the fuel storage tank inventory management system 1.

The prediction engine 2 of the fuel storage tank inventory management system 1 uses the price at which fuel is offered for sale at the filling station and the price data regarding other local filling stations as one factor affecting fuel demand at the filling station. Since the price data can be up to date real time data this allows the fuel demand and fuel stock to be accurately predicted.

In the illustrated example the central fuel price collector 41 carries out aggregation and analysis of the fuel price information received from the different fuel price reporting systems 43 and fuel storage tank inventory management systems 1 making up the fuel price data system 40 and provides the results of this analysis to the filling stations where the fuel price reporting systems 43 are located. Access to these analysis results provides an incentive for filling stations to provide their current fuel prices to the fuel price data system 40. The analysis results may include summaries and statistics of industry data in real time, or close to real time. In other examples different incentives may be offered.

In the illustrated example the operator can input a proposed fuel price change into the fuel storage tank inventory management system, together with the proposed timing of the fuel price change, for example by using the user interface 5. The fuel storage tank inventory management system 1 can then generate a prediction of future fuel demand, fuel stocks and safe delivery window if the proposed fuel price change is carried out. This feature can be used to determine the effect of proposed fuel price changes on future fuel demand, fuel stocks and safe delivery window, and to determine what effect the proposed fuel price change will have on fuel delivery requirements and/or schedules. This feature can be used to inform and assist decision making in deciding whether or not to make the proposed changes. In some examples this feature could be extended to include a number of proposed fuel price changes at different times.

If the operator decides that the proposed price change is to be executed the operator can confirm this to the fuel storage tank inventory management system 1 using the user interface 5, so that the fuel storage tank inventory management system 1 can take the price change into account in future predictions. The operator must then manually input the price change into the filling station systems, such as the site controller, at the appropriate time so that the new price can be charged to customers and any signs can be updated to display the new price.

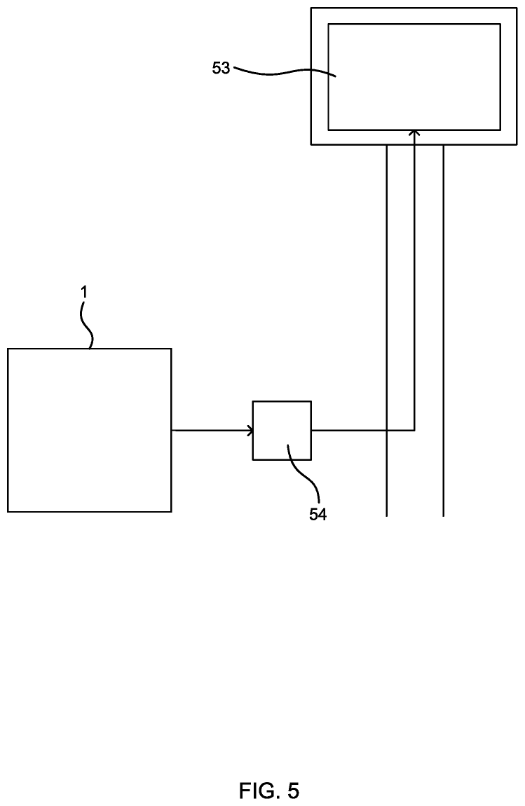

FIG. 5 illustrates a system for carrying out fuel storage tank inventory management at a specific filling station according to a further embodiment of the invention.

In FIG. 5 the filling station has an electronic display sign 53, which displays the prices of the fuel sold at the filling station. The electronic display sign 53 is controlled by a sign controller 54.

The fuel storage tank inventory management system 1 is connected to the sign controller 54 so that the fuel storage tank inventory management system 1 can instruct the sign controller 54 what fuel price to display on the display sign 53. In one example the fuel storage tank inventory management system 1 is connected to the sign controller 54 using an API.

In the embodiment of FIG. 5, when the operator confirms to the fuel storage tank inventory management system 1 that a fuel price is to be changed, the fuel storage tank inventory management system 1 will automatically inform the sign controller 54 to change the fuel price displayed on the display sign 53 to the new price. This may be carried out immediately for a current price change. Alternatively, where the price change is scheduled to take place at a specified time in the future, or in relation to a specific event such as depletion of one or more of fuel storage tanks to particular levels the fuel storage tank inventory management system 1 may inform the sign controller 54 at the specified time or upon the occurrence of the specified event.

In addition to informing the sign controller 54, the fuel storage tank inventory management system 1 may automatically inform other filling station systems of the new price, so that the new price can be charged to customers. If the fuel price change is intended to take place in the future, the fuel storage tank inventory management system 1 may wait until the proposed price change time before informing the filling station systems of the new price. The fuel storage tank inventory management system 1 may inform the filling station systems of the new price by communicating the new price to the filling station site controller.

In the illustrated example of FIG. 5 the fuel storage tank inventory management system 1 is connected directly to the sign controller 54. In other examples the fuel storage tank inventory management system 1 may be indirectly connected to the sign controller 54. For example, the fuel storage tank inventory management system 1 may be connected to another filling station system, such as the site controller, which is in turn connected to the sign controller 54.

If the operator, or the fuel storage tank inventory management system 1, implements a price change for any or every type and grade of fuel, the operator or the system using the software or firmware will also change the display in the fuel pump or pumps and price sign, signs, pole or poles associated with that type and/or grade of fuel as a visible manifestation of the changes resulting from the change in selling price of the fuel, and on any electronic point of sale systems and displays.

In the illustrated examples, if the operator becomes aware that a local filling station intends to change its fuel price in the future, the operator can input the proposed fuel price change and its expected timing into the fuel storage tank inventory management system, for example by using the user interface 5. The fuel storage tank inventory management system can then generate a prediction of future fuel demand and fuel stocks taking the intended fuel price change into account. In some examples this feature could be extended to include a number of proposed fuel price changes at different times. The filling station operator may become aware of an intended future price change at a local filling station through publicity or advertising of the planned price reduction, for example through local poster, press or social media.

In some circumstances the central fuel price collector 41 may be informed in advance that another filing station intends to change its fuel price in the future. In this case the central fuel price collector 41 may send fuel price data identifying the intended future fuel price of that filling station to any fuel storage tank inventory management systems 1 identified as local to that filling station, so that the fuel storage tank inventory management system 1 can take any intended changes to the fuel prices at the local filling stations into account in any prediction of future fuel demand and fuel stocks. In some examples this intended future price change may be reported to the central fuel price collector 41 by a fuel price reporting system 43. In some examples the intended future price change may be reported to the central fuel price collector 41 based upon identification publicity or advertising of the planned price reduction.

In the illustrated example the fuel storage tank inventory management system 1 sends fuel price notifications to the central fuel price collector 41, so that each fuel stock prediction system is also a fuel price reporting system. In other examples the fuel price notifications may be sent by a separate fuel price reporting system 43 located at the same filling station as the fuel storage tank inventory management system 1, so that the functions of the fuel storage tank inventory management system 1 and the fuel price reporting system 43 are separately provided.

In the illustrated example the baseline fuel demands for each day stored in the information store 3 may be derived from recorded historic data by data analysis techniques.

In the illustrated example the factors stored in the information store 3 may be derived from recorded historic data by data analysis techniques.

The baseline fuel demands and factors may be derived from historic fuel demand data specific to the filling station. They may also be based on general historic fuel demand data. In some examples a fuel storage tank inventory management system 1 newly installed at a filling station may start using generic factors and modify these factors over time based on fuel demand data specific to the filling station as this data is accumulated.

As is explained above, in the illustrated examples one of the factors taken into account by the prediction engine 2 is the price or prices at which fuel is offered for sale at the filling station and other nearby filling stations. Other factors may also be taken into account.

One factor which may be taken into account is predicted amounts of road traffic. This may be the general amount of road traffic across the entire country or region, which may be obtained from a government website, or from commercial and motoring organizations offering traffic management services. Alternatively, or additionally, this may be or the amount of road traffic expected on the specific roads close to, and served by, the filling station, which may be obtained from a government website, or from commercial and motoring organizations offering traffic management services. This allows for local management of fuel pricing information based on traffic density.

Another factor which may be taken into account is school holidays. Information regarding the dates of school holidays may be obtained from a government, school authority, or school website.

Another factor which may be taken into account is predicted roadworks. Information regarding roadworks may be obtained from a government website, or from commercial and motoring organizations offering traffic management services.

Another factor which may be taken into account is national and/or regional average fuel prices. In this case both the absolute value of average fuel prices and any difference between the average value and the fuel price at the filling station may be taken into account. Information regarding average fuel prices may be obtained from motoring organization websites. Further, average fuel prices may be calculated by the central fuel price collector in examples where this is used.

Another factor which may be taken into account is weather. Information regarding predicted weather may be obtained from a government website, or from commercial forecasting agencies.

The possible factors and information sources set out above are provided as examples only, and are not intended to be exhaustive.

In the illustrated example, information regarding the factors identified above may be gathered and provided to the fuel stock prediction system 1 by the central fuel price collector 41. In other examples this information may be provided to the fuel storage tank inventory management system 1 by another data collection system separate from the central fuel price collector. In other examples this information may be obtained from different sources by the fuel storage tank inventory management system itself.

If the filling station is co-located with a retail store, such as a supermarket, another factor which may be taken into account is the number of customers expected to visit the retail store. The retail store may be able to provide predictions of customer numbers based on any planned promotional events at the retail store, or anticipated promotional events at rival stores.

As is explained above, In the illustrated example the operator can input a proposed fuel price change into the fuel storage tank inventory management system, together with the proposed timing of the fuel price change, use this to determine the effect of proposed fuel price changes on future fuel demand and fuel stocks, and to determine what effect the proposed fuel price change will have on fuel delivery requirements and/or schedules. If it is intended to publicize the proposed fuel price change, for example if it is a price reduction, a further factor which may be taken into account is the scale and duration of the publicity. For example, what communication channels are used, the number and size of the publicity materials, and the duration.

The price change in the fuel is automatically or manually entered into the fuel pole signs and the pump price indicators as a visual display. Any actual change in the price of any fuel or grade of fuel will be expected to affect the rate at which the or each storage tank for that fuel is depleted, and such price change is therefore fed into the predictor 2, and its effects on demand predicted by the predictor 2.

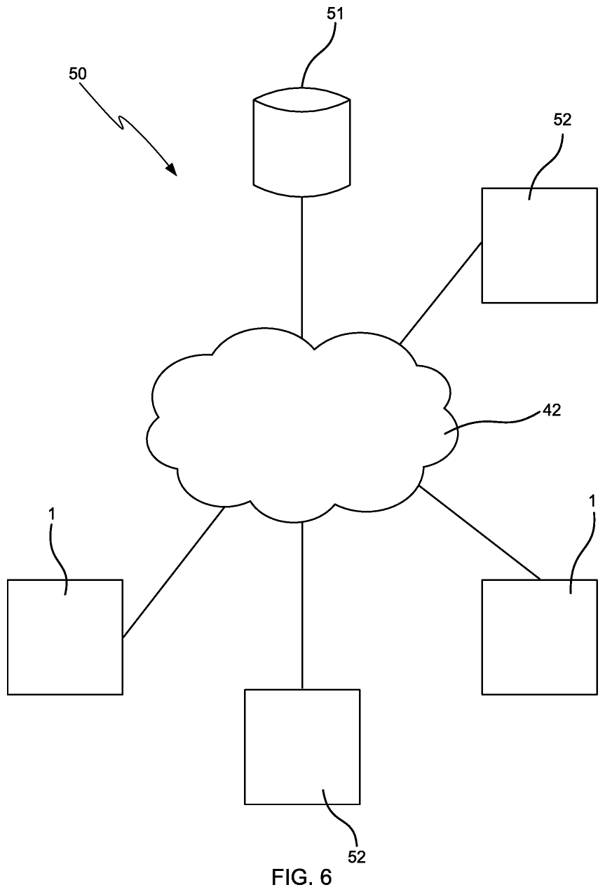

FIG. 6 illustrates a fuel cost data system for providing the fuel storage tank inventory management system 1 with real time and predictive data regarding wholesale fuel prices.

In FIG. 6, the fuel cost data system 50 comprises a central fuel cost collector 51. The fuel cost collector 51 is connected to a number of different fuel storage tank inventory management systems 1 located at respective different filling stations through the communications network 42. The central fuel cost collector 51 is also connected to a number of fuel suppliers 52 through the communications network 42. FIG. 4 shows only two fuel suppliers 52 and two fuel storage tank inventory management systems 1. It will be understood that in practice there may be any number of fuel suppliers 52 and fuel storage tank inventory management systems 1 in the fuel cost data system 50.

The central fuel cost collector 51 may be arranged to operate as a server.

In operation the central fuel cost collector 51 obtains information regarding current fuel supply costs from each of the fuel suppliers 52. The central fuel cost collector 51 stores this fuel supply cost information and analyses the stored information to determine whether the prices and costs of each supplier, and possibly the market as a whole, are currently tending to reduce or increase over time, that is, whether the prices and costs are rising or falling.

The central fuel cost collector 51 is central in the sense that it is a central part of the functionality and organization of the system. The term central does not imply anything regarding the physical or geographical location of the different parts of the system.

The central fuel cost collector 51 sends each fuel storage tank inventory management system 1 fuel cost data identifying whether the cost of fuel for supply to the filling station is currently rising or falling. In one example this cost data is sent periodically. The fuel cost data identifying whether the cost of fuel for supply to the filling station is currently rising or falling may be displayed to the user, for example using the user interface.

The stored site specific characteristic data may include fuel cost data specific to the filling station, for example any site specific delivery costs additional to the general market fuel cost, such as the wholesale fuel spot price.

As discussed above, the fuel storage tank inventory management system 1 provides the operator with the available safe window for receiving fuel deliveries, so that fuel deliveries can be arranged at an advantageous time within this window. In the example of FIG. 4 the fuel storage tank inventory management system may also inform the operator whether the cost of fuel for supply to the filling station is currently rising or falling, enabling this fact to be taken into account when scheduling the fuel delivery.

In general, the price paid for fuel by a filling station is the market price at the time of delivery. Accordingly, appropriate scheduling of a fuel delivery may allow the cost to be minimized, potentially increasing the filling station profit margins. In general it will be advantageous to schedule fuel deliveries as soon as possible when prices are rising, and to delay fuel deliveries within the identified available safe window when prices are falling, subject normally to not delaying the delivery and replenishment of the storage tank or tanks for so long that the storage tank(s) are emptied and the associated pumps at the filling station shut down. Any delay in the scheduled fuel deliveries may also be subject to constraints set out in the stored site specific characteristics.

In many cases filling stations are contractually required to source their fuel from a specific supplier. Further, even when this is not the case, some suppliers may only supply filling stations in a specific geographical area. Accordingly, the central fuel cost collector 51 may send the fuel stock prediction system 1 only fuel cost data relating to a fuel supplier or suppliers from which the filling station is able to order fuel.

In the examples described above the fuel storage tank inventory management system is provided with price data from a fuel price data system comprising a fuel price collector and a number of fuel price reporting systems located at filling stations. This is not essential. In other examples fuel price information regarding some, or all, of the filling stations may be provided to the fuel price collector by other means.

In some examples fuel price information may be automatically obtained remotely from an electronic system at a filling station, such as a site controller, a smart controller or smart interface of a pay-at-pump system, or an epos system. This is not intended to be an exhaustive list, and other arrangements may be possible. In some examples fuel price information may be automatically obtained from epos data sent to third parties. In some examples fuel price information may be obtained from a vehicle fleet operator, or from fuel card data provided by a fuel card company.

In some examples fuel price information may be automatically obtained from a website operated by the filling station or the company operating the filling station.

In some examples fuel price information may be automatically obtained by an image capture device, such as a camera, viewing a price display sign at the filling station. Off the shelf optical character recognition technology is able to reliably obtain price information from an image of a sign. In some examples the image capture device could send the captured image to a server, such as the fuel price collector, for character recognition processing and data capture to reduce the processing and power requirements at the image capture location.

In some examples fuel price information may be manually obtained from filling stations. In one example an app could be provided to allow persons with smartphones, or other mobile devices, to take pictures of price display signs at filling stations, and send them to the fuel price collector together with location information. The received images can then be processed to obtain price information, and this price information can be associated with a filling station based on the associated location information. In such a crowdsourced approach the persons sending the pictures may be incentivized to provide them in various ways, for example by micro-payments, or some form of gamification.

In the examples described above the fuel storage tank inventory management system is provided with price data from a fuel price data system comprising a fuel price collector and a number of fuel price reporting systems located at filling stations. This is not essential. In other examples fuel price information regarding some, or all, local filling stations may be provided to the fuel storage tank inventory management system directly without any separate fuel price collector.

In one example, a simple approach would be for an employee to travel to, or access websites of, the local filling stations of interest and directly observe the current fuel price. These observed fuel prices can then be entered into the fuel storage tank inventory management system using the user interface.

In some examples without any separate fuel price collector, the approaches described above in which fuel price information is automatically obtained remotely from an electronic system at a filling station, such as a site controller, a smart controller or smart interface of a pay-at-pump system, or an epos system, by an image capture device, such as a camera, viewing a price display sign at the filling station, or by crowdsourcing, may be applied to local filling stations of interest only, with the fuel price information being provided directly to the fuel storage tank inventory management system.

In the illustrated example of FIG. 6 the fuel storage tank inventory management system is provided with fuel cost data from a fuel cost data system comprising a fuel cost collector. This is not essential. In other examples fuel cost information may be provided to the fuel storage tank inventory management system directly without any separate fuel cost data system. In some examples without any separate fuel cost data system the fuel storage tank inventory management system may obtain fuel cost information directly from a fuel supplier or suppliers and determine whether the prices and costs of the supplier(s) are currently tending to reduce or increase over time, that is, whether the prices and costs are rising or falling.

In the examples described above a prediction engine is described. Other types of prediction engine may be used.

In the examples described above the stored information inputs for each factor affecting fuel demand are processed in order. This may be a predetermined order.

In the examples described above the prediction engine determines a baseline value for fuel consumption, and then altered this value based on the stored information inputs for each factor affecting fuel demand. In other examples different prediction techniques may be used. In some examples the stored information inputs for multiple factors may be processed to generate an overall alteration value, which is then applied to the baseline value. In some examples the fuel consumption may be derived directly from the stored information inputs using known techniques for making predictions based on comparisons between different datasets. In some examples the prediction engine may be a neural network trained using historical data.

While the examples above have been primarily described with reference to a single type or grade of fuel, where a filling station has multiple types and grades of fuel, the predictions across types and grades of fuels may be made separately, or aggregated so as to produce a single prediction across some or all such types and grades of fuel.

In the examples described above the fuel storage tank inventory management system is located at the filling station. In other examples all, or part, of the fuel storage tank inventory management system may be located remotely from the filling station. In some examples all, or part, of the fuel storage tank inventory management system may be provided by a remote server. In some examples the all, or part, of the fuel storage tank inventory management system may be cloud based.

As is explained above, the examples described above refer primarily to only a single fuel type and grade stored in a single tank for simplicity. In the common situation of a filling station selling multiple different fuel types and grades stored in multiple tanks the fuel stock levels of the different fuel types and grades in the different tanks may all be predicted and controlled. In some examples this may be done using a single fuel storage tank inventory management system using appropriate data and algorithms for each unique combination of fuel type, grade and tank. In some examples this may be done using a separate dedicated fuel storage tank inventory management system for each unique combination of fuel type, grade and tank. In examples where multiple separate fuel storage tank inventory management systems are used these may be provided by different instances of fuel storage tank inventory management system software running on a single set of hardware.

Where the fuel storage tank inventory management system is located at a filling station selling a specific fuel and grade stored in multiple storage tanks the stored site specific characteristic data may include the relative rate at which the total amount of that fuel and grade sold is taken from different ones of the storage tanks. Where the fuel storage tank inventory management system is located at a filling station selling multiple different fuel types and grades stored in multiple storage tanks the stored site specific characteristic data may include the connection and correlation between the demands for, and rates of tank depletion of, the different fuels and/or grades. These site specific characteristics may be determined form historical data by suitable data analysis. Knowing these site specific characteristic may simplify and make more accurate any aggregation of different fuels, grades and/or tanks in the fuel storage tank inventory management system.

In the examples described above the predictions of fuel demand and fuel stock levels are generated in time sequence over a period of time. It is not essential that the predictions of fuel demand for different times, such as different days, are carried out in any particular sequence. However, in order to predict fuel stock levels it is necessary to compare the predictions of fuel demand to the stored fuel amount sequentially in order to correctly predict the remaining fuel stock values.

In the examples described above the predictions of fuel demand and fuel stock levels start from the current time. In some examples further predictions could be made starting from future times. For example, further predictions could be made starting from the scheduled time of a next fuel delivery in order to schedule a future fuel delivery.

The examples described above relate to a retail filling station situation, and in particular to the effect on demand of fuel prices in a retail situation. It should be understood that the fuel prices will still affect demand even if the filing station supplies some fuel to customers who are required to use the filling station, for example fleet vehicles under a supply contract.

The examples described above predict fuel demand and fuel stock levels on a daily basis. In other examples different time periods may be used.

In the examples described above the user interface may be used to provide further information and messages in addition to those described to the operator.

In the examples described above the fuel price data system and the fuel cost data system are push type systems where data is sent automatically by a data sender. In other examples either or both may be pull type systems where data is requested by a data receiver.

Some examples of the invention described above include approaches where fuel price data is provided manually by filling station personnel or is crowd sourced from members of the public. In such embodiments cross checking and plausibility checks may be used to verify the likely accuracy of the fuel price data received before the data is used in order to prevent accidental errors and/or deliberate distortion, which may be intended to manipulate fuel prices at other filling stations.

The examples of the invention described above are described as using a single communications network. In other examples the invention may be carried out in situations involving any number of communications networks.

In the examples described above the central fuel price collector and the central fuel cost collector may comprise a server. In some examples the functionality of these elements may be provided by a network of servers.

In the example described above a user at the filling station is referred to. This may be a single user or a number of different users.

In the described examples the components may be hardware components or logical components such as software modules or elements.

The examples described above relate to predicting an amount of a fuel stored at a filling station. In other examples the invention may be used to predict amounts of other locally stored goods where sale volumes are expected to be influenced by local price differentials.

In the described examples of the invention the fuel storage tank inventory management system may be implemented as any form of a computing and/or electronic device.

Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

The computer executable instructions may be provided using any computer-readable media that is accessible by computing based device. Computer-readable media may include, for example, computer storage media such as a memory and communications media. Computer storage media, such as a memory, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media.

Although the fuel storage tank inventory management system is shown as a single device it will be appreciated that this system may be distributed or located remotely and accessed via a network or other communication link (e.g. using a communication interface).

The term ‘computer’ is used herein to refer to any device with processing capability such that it can execute instructions. Those skilled in the art will realise that such processing capabilities are incorporated into many different devices and therefore the term ‘computer’ includes PCs, servers, mobile telephones, personal digital assistants and many other devices.

Those skilled in the art will realise that storage devices utilised to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realise that by utilising conventional techniques known to those skilled in the art that all, or a portion of the software instructions may be carried out by a dedicated circuit, such as a DSP, programmable logic array, or the like.

Any range or value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1-39. (canceled)

40. A computer implemented system for fuel storage tank inventory management at a filling station, the system comprising:
a fuel demand predictor arranged to predict future fuel demand for the fuel at the filling station;
a data store containing stored information regarding current and anticipated future factors which may influence current and future fuel demand;
wherein the fuel demand predictor is arranged to predict future fuel demand for the fuel at the filling station based at least in part upon the stored information regarding current and anticipated future factors; and
further comprising:
a fuel stock means arranged to obtain a current amount of the fuel stored at the filling station;
a fuel stock predictor arranged to predict a future amount of the fuel stored at the filling station based upon the current amount of the fuel at the filling station and the predicted future fuel demand for the fuel at the filling station; and
output means arranged to output the predicted future amount of the fuel stored at the filling station.

41. The system according to claim 40, wherein the system further comprises:
a local fuel price obtaining means arranged to obtain a local fuel price for the fuel at the filling station; and
a fuel price obtaining means arranged to obtain a fuel price for the fuel for at least one other filling station; and
wherein the fuel demand predictor is arranged to predict future fuel demand for the fuel at the filling station based at least in part upon the local fuel price at the filling station and the fuel price for the at least one other filling station.

42. The system according to claim 40, wherein the system further comprises means arranged to determine a safe time window for receiving a fuel delivery from the predicted future amount of the fuel; and
the output means is further arranged to output the end of the determined safe time window.

43. The system according to claim 41, wherein the means arranged to determine a safe time window for receiving a fuel delivery from the predicted future amount of the fuel makes the determination by comparing the predicted future amount of the fuel to a threshold.

44. The system according to claim 40, wherein the fuel stock predictor is arranged to predict the future amount of the fuel stored at the filling station at a plurality of different times.

45. The system according to claim 44, wherein the fuel stock predictor is arranged to predict the future amount of the fuel stored at the filling station on each of a number of time periods.

46. The system according to claim 45, wherein the fuel stock predictor is arranged to predict the future amount of the fuel stored at the filling station at the end of each time period, or at a designated time in each time period.

47. The system according to claim 45, wherein each time period is a day.

48. The system according to claim 41, wherein the fuel price obtaining means is arranged to obtain a current fuel price for the fuel for the at least one other filling station.

49. The system according to claim 41, wherein fuel price obtaining means is arranged to obtain a proposed future fuel price for the fuel for the at least one other filling station, and the fuel demand predictor is arranged to predict future fuel demand for the fuel at the filling station based at least in part upon this proposed future fuel price.

50. The system according to claim 41, wherein the local fuel price obtaining means is arranged to obtain a current local fuel price for the fuel at the filling station.

51. The system according to claim 41, wherein the local fuel price obtaining means is arranged to obtain a proposed future local fuel price for the fuel at the filling station, and the fuel demand predictor is arranged to predict future fuel demand for the fuel at the filling station based at least in part upon this proposed future local fuel price.

52. The system according to claim 41, wherein the at least one other filling station is located locally to the filling station.

53. The system according to claim 41, wherein the fuel price obtaining means is arranged to obtain current fuel prices for the fuel at a plurality of other filling stations.

54. The system according to claim 41, wherein the fuel price obtaining means is arranged to obtain expected future fuel prices for the fuel at a plurality of other filling stations.

55. The system according to claim 54, wherein the plurality of other filling stations are located locally to the filling station.

56. The system according to claim 40, wherein the current amount of the fuel stored at the filling station is the current total amount of the fuel stored at the filling station.

57. The system according to claim 40, wherein the current amount of the fuel stored at the filling station is the current amount of the fuel stored in one or more storage tanks at the filling station.

58. The system according to claim 40, wherein the current amount of the fuel stored at the filling station is the current amount of the fuel stored in a specific storage tank at the filling station.

59. The system according to claim 58, wherein the system further comprises a fuel level sensor arranged to sense the amount of fuel in the specific storage tank and to provide this amount as the current amount of the fuel stored at the filling station.

60. A computer implemented method for fuel storage tank inventory management at a filling station, the method comprising:
predicting, by a computer, future fuel demand for the fuel at the filling station;
obtaining, by the computer, stored information regarding current and anticipated future factors which may influence current and future fuel demand from a data store;
wherein future fuel demand for the fuel at the filling station is predicted based at least in part upon the stored information regarding current and anticipated future factors; and
further comprising:
obtaining, by the computer, a current amount of the fuel stored at the filling station;
predicting, by the computer, a future amount of the fuel stored at the filling station based upon the current amount of the fuel at the filling station and the predicted future fuel demand for the fuel at the filling station; and
outputting, by the computer, the predicted future amount of the fuel stored at the filling station.

61. The method according to claim 60, and further comprising:
obtaining, by the computer, a local fuel price for the fuel at the filling station; and
obtaining, by the computer, a fuel price for the fuel for at least one other filling station; and
wherein future fuel demand for the fuel at the filling station is predicted based at least in part upon the local fuel price at the filling station and the fuel price for the at least one other filling station.

62. The method according to claim 60, and further comprising determining, by the computer, a safe time window for receiving a fuel delivery from the predicted future amount of the fuel; and
outputting, by the computer, the end of the determined safe time window.

63. The method according to claim 62, wherein the determining the safe time window comprises comparing, by the computer, the predicted future amount of the fuel to a threshold.

64. The method according to claim 60, wherein the method comprises predicting, by the computer, the future amount of the fuel stored at the filling station at a plurality of different times.

65. The method according to claim 64, wherein the method comprises predicting, by the computer, the future amount of the fuel stored at the filling station on each of a number of time periods.

66. The method according to claim 63, wherein the method comprises predicting, by the computer, the future amount of the fuel stored at the filling station at the end of each time period, or at a designated time in each time period.

67. The method according to claim 60, wherein each time period is a day.

68. The method according to claim 61, wherein the method comprises obtaining, by the computer, a current fuel price for the fuel for the at least one other filling station.

69. The method according to claim 61, wherein the method comprises obtaining, by the computer, a proposed future fuel price for the fuel for the at least one other filling station, and predicting, by the computer, future fuel demand for the fuel at the filling station based at least in part upon this proposed future fuel price.

70. The method according to claim 61, wherein the method comprises obtaining, by the computer, a current local fuel price for the fuel at the filling station.

71. The method according to claim 61, wherein the method comprises obtaining, by the computer, a proposed future local fuel price for the fuel at the filling station, and predicting, by the computer, future fuel demand for the fuel at the filling station based at least in part upon this proposed future local fuel price.

72. The method according to claim 61, wherein the at least one other filling station is located locally to the filling station.

73. The method according to claim 61, wherein the method comprises obtaining, by the computer, current fuel prices for the fuel at a plurality of other filling stations.

74. The method according to claim 61, wherein the method comprises obtaining, by the computer, expected future fuel prices for the fuel at a plurality of other filling stations.

75. The method according to claim 73, wherein the plurality of other filling stations are located locally to the filling station.

76. The method according to claim 60, wherein the current amount of the fuel stored at the filling station is the current total amount of the fuel stored at the filling station.

77. The method according to claim 60, wherein the current amount of the fuel stored at the filling station is the current amount of the fuel stored in one or more storage tanks at the filling station.

78. The method according to claim 60, wherein the current amount of the fuel stored at the filling station is the current amount of the fuel stored in a specific storage tank at the filling station.

79. The method according to claim 78, wherein the current amount of the fuel stored at the filling station is obtained from a fuel level sensor arranged to sense the amount of fuel in the specific storage tank.

80. A computer program comprising a plurality of computer readable instructions arranged such that, when executed on a processor of the computer they cause the computer to carry out the method according to claim 60.
